(19) United States
(12) Patent Application Publication
(10) Pub. No.: US 2026/0161262 A1
(43) Pub. Date: Jun. 11, 2026

(54) SMART PERFORMANCE ANALYSIS AND ANOMALY DETECTION FOR HPC AND AI SYSTEMS

(71) Applicant: Hewlett Packard Enterprise Development LP, Spring, TX (US)

(72) Inventors: Nilakantan Mahadevan, Bloomington, MN (US); Duncan Roweth, Briston (GB); Laurence Scott Kaplan, Seattle, WA (US); Amith Abraham, Milpitas, CA (US)

(21) Appl. No.: 18/975,656

(22) Filed: Dec. 10, 2024

(51) Int. Cl. G06F 3/04815; G06T 1/20

(52) U.S. Cl. CPC G06F 3/04815; G06T 1/20

(57) ABSTRACT

Techniques for analyzing performance and detecting anomalies for complex large-scale systems are provided herein. More specifically, the present disclosure provides the ability to identify events of interest in counter samples using markers and correlating metrics from different entities (switch, NIC, CPU, GPU, PCIe, memory). In contrast to previous visual representations, the correlated events of the current techniques enable an enhanced visual representation that focuses on the identified events and a timeline correlation of different metrics to understand job performance variations.

### BACKGROUND

The present disclosure relates generally to techniques for analyzing performance and detecting anomalies for complex large-scale systems. More specifically, the present disclosure provides the ability to identify events of interest in performance counter samples by using markers and correlating metrics from different entities (e.g., a network switch, network interface card/controller (NIC), central processing unit (CPU), graphics processing unit (GPU), peripheral component interconnect express (PCIe), and/or memory).

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

A typical high-performance computing (HPC) and/or artificial intelligence (AI) system can have thousands of nodes consisting of CPUs and GPUs along with high-speed network interfaces (HSN NICs). These nodes are connected using a high-performance network fabric using thousands of switches in a network topology like fat tree or dragonfly. A large HPC job and its constituent applications may be quite complex and may run on a multitude of these hosts for an extended amount of time (e.g., multiple hours).

Performance counters may be used to monitor and report on components of the system. Performance counters are hardware and/or software elements that monitor, count, and/or measure events within hardware and/or software, enabling performance analytics of the hardware and/or software of the system. Using these performance counters, valuable information may be gleaned about the system and/or HPC and/or AI jobs within the system.

Counter sampling on hosts and fabric are typically independent activities, where the counter samples for hosts are stored separately from the counter samples for the fabric. Further, these different counter samples typically utilize different schemas and/or different persistent databases. Host counter collection is initiated on nodes on which a particular job is being executed. Fabric counter collection (e.g., from switches connecting the nodes) is typically common for all jobs using the nodes.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1A is a diagram, illustrating a system with different sets of counters for performance analysis and anomaly detection, in accordance with aspects of the present disclosure;

FIG. 1B is a diagram, illustrating a system with pre-processing and post-processing engines, in accordance with aspects of the present disclosure;

FIG. 2 is a flowchart, illustrating a process used for efficient counter sample analysis, in accordance with aspects of the present disclosure;

FIG. 3A is a diagram, illustrating an example of marker insertion with respect to host metrics counter samples, in accordance with aspects of the present disclosure;

FIG. 3B is a diagram, illustrating an example of marker insertion with respect to fabric metrics counter samples, in accordance with aspects of the present disclosure;

FIG. 4 is a is a flow chart, illustrating a process for correlation of and visual presentation of counter samples, in accordance with aspects of the present disclosure;

FIG. 5 is a diagram, illustrating an example event data obtained via extraction of markers, in accordance with aspects of the present disclosure;

FIG. 6A is a diagram, illustrating a system that correlates counter samples across fabric, host NIC and host system domains, in accordance with aspects of the present disclosure;

FIG. 6B is a diagram, illustrating cross-correlated counter samples resulting from cross-correlation of the counter samples, in accordance with aspects of the present disclosure;

FIG. 7 depicts a depicts a graphical user interface (GUI) visualization of a visualization tool, in accordance with aspects of the present disclosure;

FIG. 8 depicts a GUI visualization of a visualization tool that provides a visual representation of correlated events, in accordance with aspects of the present disclosure.

### DETAILED DESCRIPTION

One or more specific aspects of the present disclosure will be described below. In an effort to provide a concise description of these aspects, all features of an actual implementation may not be described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various aspects of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

In addition, as used herein, the terms “real time”, “real-time”, or “substantially real time” may be used interchangeably and are intended to describe operations (e.g., computing operations) that are performed without any human-perceivable interruption between operations. In addition, as used herein, the terms “automatic”, “automated”, “autonomous”, and so forth, are intended to describe operations that are performed and/or are caused to be performed, for example, by a computing system (i.e., by the computing system, without human intervention).

Job performance analysis and anomaly detection for large-scale systems (e.g., high-performance computing (HPC) and/or artificial intelligence (AI) systems) can be a complex and challenging task. First, actively monitoring a large-scale system is a challenge. For example, a system with 5000+ switches may have upwards of 80,000 host endpoints and ˜220,000 fabric endpoints to be actively monitored for a job. Second, there are different types of metrics that are involved such as fabric counters (e.g., monitoring network components such as switches), a different set of NIC counters on the on the hosts, and a set of host system level counters on the hosts. Raw data alone may be insufficient to determine the health of the fabric because the metrics provided by the various counters of the system are interrelated and should be evaluated in conjunction. Performance analysis thus involves analysis of counters from all the entities because failures or events in any one of them could cause anomalies and variations. Real-time analysis of such large jobs is desired so that any corrective action can be taken to avoid wasting valuable time and resources.

However, it may be difficult to provide effective analysis and scalability for complex large-scale environments. For example, it may take significant processing and computing resources for visualization tools to load and analyze a large number (e.g., 80,000) of high-speed network (HSN) endpoints and enable timeline correlation. Indeed, with ever-increasing system complexity this scaling problem may continue to increase and run into additional resource constraints (memory and CPU resources). However, the added complexity of these systems illustrates the desirability for enhanced analysis and visualization. Indeed, performance implications may exist due to network errors, resulting in “stalls” in applications. Enhanced ability to efficiently identify the root cause of stalls and their impacts may be useful in prioritization and mitigation of system issues.

The current aspects provide such efficiency improvements in system performance evaluation and analysis. To do this, anomalies within each of the counter samples of the various system components are identified and “marked” (e.g., by inserting a mark indication within and/or associated with the counter data). Time-based correlation of the marked portions is then provided, indicating zones of interest within the various counter samples. This correlated counter data enables efficient analysis and visualization, supporting efficient issue mitigation within the system. For example, in a large high-performance computing (HPC) installation, a high-performance LINPACK (HPL) job executing on 9000 nodes was executed for multiple hours and had “stalls” in different stages of execution from a few seconds to several minutes. With the analysis and visualization efficiencies provided herein, pinpointing the events of interest (i.e., occurrence of a counter sample event indicated in a counter sample and/or changes in the performance metrics of a counter sample that breaches an associated event-defining threshold), issue prioritization for mitigation was significantly improved.

Counter sampling on hosts and fabric are typically independent activities, where the counter samples for hosts are stored separately from the counter samples for the fabric and with different schemas and/or different persistent databases. Host counter collection (for both NICs and system) is initiated on nodes on which a particular job is being executed. Fabric counter collection (from switches) is common for all jobs. Fabric counter collection on the switch side for edge ports may be in correlation to the hosts on which the jobs are launched. The techniques provided herein facilitate a combined analysis based on both host and fabric counters relevant to a job. In this manner, events indicated in the fabric counter samples during the jobs (for example a link failure, lack of buffers in ports, invalid switch configuration, switch failures, correctable/uncorrectable errors) may be correlated with host counter samples to identify correlations between performance variations or job failure to specific events. Thus, using the techniques provided herein, host system level metrics (cache misses, Interrupts, PCIe counters, correctable and uncorrectable errors) may be analyzed to understand the system level impact on a job (e.g., at the fabric level).

The present disclosure relates generally to analyzing performance and detecting anomalies for any systems of any size and/or complexity. More specifically, the present disclosure relates to providing the ability to identify events of interest in counter samples using markers that are introduced in a pre-processing stage. Using the markers, metrics from different entities (switch, NIC, CPU, GPU, PCIe, memory) are correlated (e.g., via a post-processing engine (PPE) downstream of counter sample collection). The correlated events from the various counter samples may facilitate prioritized analysis, mitigation, and/or visualization, by providing an indication of cross-counter correlated events and/or counter sample “zones” of interest, which may provide prioritized zones within counter data where correlated events occurred. This proposed system is applicable for any large-scale system with any network topologies (e.g., dragonfly and/or fat tree).

The current techniques provide a method to compute derived metrics from the raw counters. This enables visual representations to be made with a subset of desired metrics even for a fabric with a significant number (e.g., 300,000) of endpoints. The correlated events of the current techniques enable an enhanced visual representation that focuses on the identified events of interest and a timeline correlation of different metrics to understand job performance variations.

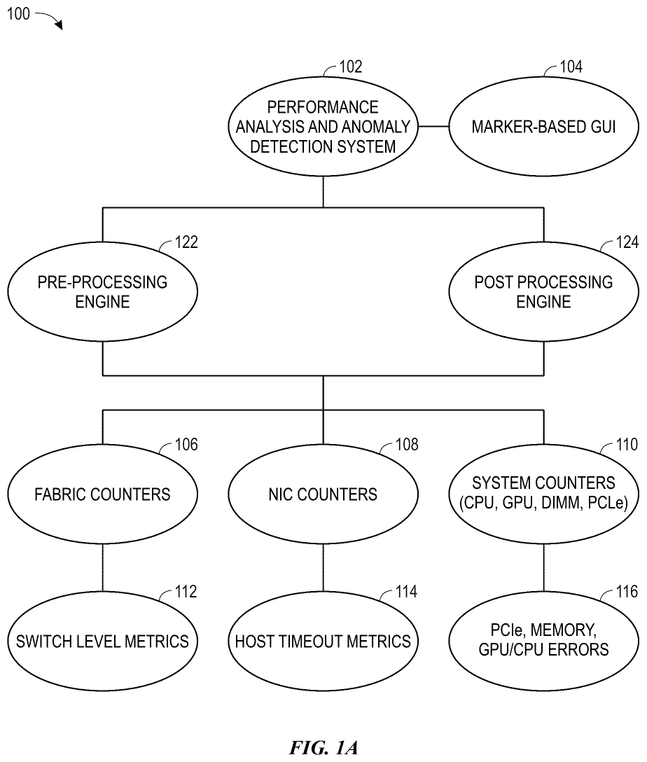

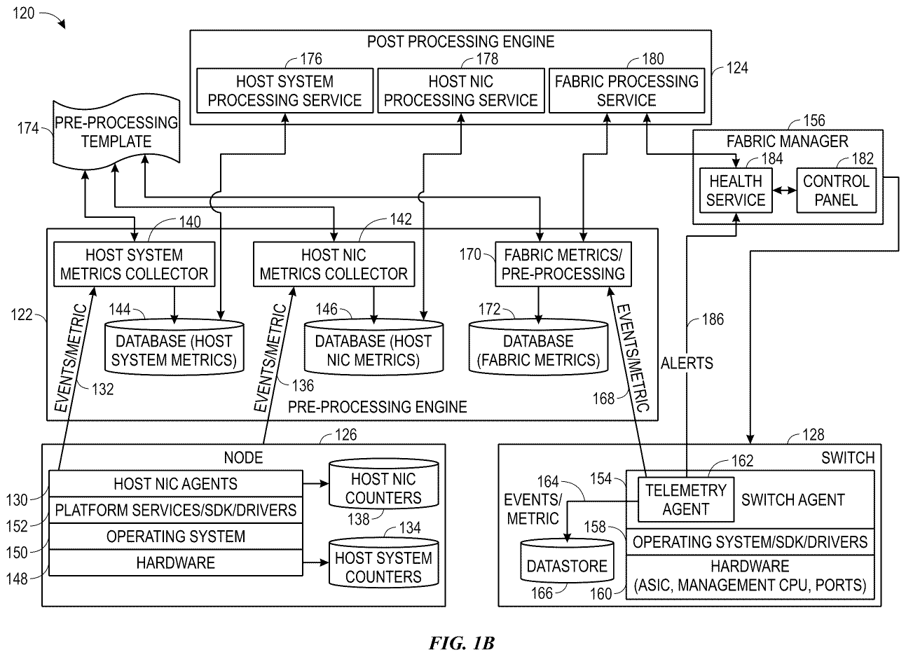

With this in mind, FIG. 1A is a diagram, illustrating a system 100 that provides marker-based correlation of events across a plurality of different types of counter samples. HPC jobs may use a number of hosts connected via a fabric. Accordingly, a combination of performance information regarding these hosts, their underlying system performance, and performance of the fabric (e.g., network) coupling these hosts may be useful in an analysis of the HPC job. The run time of these jobs could occur over an extended period of time (e.g., multiple hours), performance variations in the job should include analysis of fabric (e.g., network) counters as well as host NIC and host system counters to understand an impact of each of these entities on the job.

To this end, a Performance Analysis and Anomaly Detection System 102 of the system 100 is tasked with obtaining counter samples from a plurality of different counters, identifying and marking anomalies within the counter samples and cross-correlating the marked anomalies across the plurality of samples. The cross-correlated anomalies may be used to provide enhanced analysis tools, such as a Marker-Based graphical user interface (GUI) 104 that provides an indication of the marked anomalies across the plurality of counter samples and/or provides an indication of particular “zones of interest” that include portions of the counter samples that include cross-correlated marked anomalies.

In the depicted system 100, the Performance Analysis and Anomaly Detection System 102 receives counter samples from three sets of performance counters: fabric counters 106, host side Network Integrated Controller (NIC) counters 108, and host system counters 110, each of which is used in conjunction with an HPC job.

Fabric counters 106 are counters that track and provide performance metrics with respect to network components, such as switches. For example, these counters may provide per port performance metrics with respect to switches of the system 100.

Host side NIC counters 108 provide performance metrics at a host level (e.g., for each NIC of a host). These host side NIC counters 108 may provide an indication of high-speed network performance data specific to a host.

System counters 110 provide host-level performance metrics of a particular host. For example, system counters 110 may provide performance data such as cache misses, Interrupts, PCIe counters, correctable and uncorrectable errors with memory, other CPU and GPU events and counters.

The Performance Analysis and Anomaly Detection System 102, upon receiving counter samples from the fabric counters 106, host side NIC counters 108, and the system counters 110, may identify, mark, and cross-correlate anomalies from the counter samples. The marked and cross-correlated anomalies are used to dynamically update the Marker-Based GUI 104 to indicate the marked anomalies and/or zones of interest, as will be discussed in more detail below.

To correlate host side counters 108 and 110 with the fabric counters 106, a pre-processing engine 122 of the Performance Analysis and Anomaly Detection System 102 provides a pre-processing technique that is introduced during metrics collection. The pre-processing technique processes samples and uses “markers” during the recording of these counters in a database. These “markers” signify priority events or periods where counters exceed known good thresholds. The known good threshold, otherwise referred to as event thresholds, may, in some cases, provide a value that when breached by one of the counter values indicates a markable event. In some cases, these thresholds may indicate statistical anomaly values that when breached by a counter value indicate that the counter value is anomalous. In some cases, events may be identified in the counter samples without comparison to a particular threshold. For example, the presence of particular indicators in the counter samples, such as an indication of a timeout and/or uncorrectable error within the counter samples may indicate an event, such that markers may be generated for these events as well. Events may be indicated in the fabric counters 106, host side NIC counters 108, and/or host system counters 110. The markers are recorded along with the sample data in the database. These are applicable for raw counters as well as counter deltas (differences from previous samples).

A framework is provided to specify the counters and the corresponding thresholds that represent events of interest for pre-processing. This framework includes a template that specifies the counters and the corresponding thresholds that should be used for recording markers and specifies counters/metrics that signify priority events. In some cases, the thresholds for particular counters may be set by a user in a graphical user interface (GUI). In some cases, particular priority counter samples may be defined (e.g., in the GUI) to indicate priority events to be emphasized when the indicated counter samples breach their threshold.

A post processing engine (PPE) 124 of the Performance Analysis and Anomaly Detection System 102 analyzes the counter sample from the hosts in the job and the components (e.g., switches) in the fabric. PPE 124 is a generic framework implemented as a dynamic pluggable interface to provide the relevant logic for analysis. PPE 124 analyzes host counters 108 and 110 and fabric counters 106. The engine extracts markers from various timelines which are used in conjunction with counters from the switch or host side.

PPE 124 uses these “markers” to correlate both fabric and host side metrics in which the markers do not need to exist in both host and fabric. PPE 124 uses both fabric and host side metrics for further analysis of anomaly detection and performance variations. For example, a timeout marked on the host side NIC counter 114 may result in processing the following: switch side performance counters for the corresponding timeline to find any fabric events around that time, NIC specific events on other hosts involved in the job that have occurred in that time period that may have caused the event, performance metrics for that time period on the host side of all hosts in the job to produce analysis on the performance impact, and performance metrics on the fabric side to look for impact.

For example, host timeout metrics 114 can be extracted with markers by the PPE 124. The timeouts can be instances when packets are lost, and job performance is impacted. The lost packets may be due to either fabric level events, remote side NIC issues, or system events (PCIe, DIMM, CPU, GPU).

For example, when a marker on the switch side counter is associated with dropped packets due to delayed link failures or congestion (lack of processing buffers), the PPE 124 will analyze the host side for any variations in performance or timeouts during that time. Switch level congestion may be due to a lack of buffers on edge port in the switches to hold the frames. This condition may lead to dropped packets and thereby affect the performance of the application. Accordingly, the PPE 124 can also analyze host system counters 110 for host events (PCIe, memory, GPU/CPU errors) 116 and related errors that have occurred in that time period.

Switch level metrics 112 on dropped packets on different fabric ports can be caused by an invalid routing state. This affects job performance as lost packets need to be retransmitted. The PPE 124 can correlate with host side metrics during this timeline to provide the desired impact analysis.

Correlation of events and/or metrics across different counters may facilitate root cause analysis for a number of different situations. For example, the PPE 124 can also detect a high stall time on the host side (e.g., for memory reads/writes, PCIe errors, or other errors) which is indicated by a derived metric from other metrics. The post processing engine 124 can also interface with a Fabric Manager (control plane) to get health events during the time period for analysis, as discussed in more detail in FIG. 1B. An additional example of analyzing timeout or any variations in performance is to use a marker on the host side to correlate specific remote endpoints, resulting in isolating an individual “rank” or set of “ranks” impacted at that time.

For example, to correlate host side counters 108 and 110 with fabric side counters 106 for events during that associated time period on the host side and on the fabric side, a timeout on the host side 114 when recorded at time t1, t2, . . . tn has a marker recorded in the sample. Post processing engine 124 will match the time period (t1, t2, and tn) of all markers on the host side. This time period is used to analyze fabric side counters 106 for the same time period. In another example, dropped packets on the fabric side have a marker recorded at the time of the event (t1, t2, and tn). Post processing engine 124 uses this time period and looks for performance anomaly on the host side counters 108 and 110. In another example, a host side system event (PCIe, memory, GPU/CPU errors) 116 is recorded as markers and corresponding host side NIC counters 108 are analyzed at the sample for performance anomaly.

The PPE 124 can help reduce the data when visualization tools are not capable of loading vast amounts of data to provide visual representation due to a lack of resources. For example, when visualization tools are not capable of loading vast amounts of data due to a lack of resources, the post processing engine 124 analyzes the counter sample and provides less voluminous and more targeted derived metrics which are associated with events to understand the job's performance variations and/or failures.

The PPE 124 can also perform an analysis of when host system level metrics are used in correlation with host NIC counters 108 and fabric counters 106. For example, the sampling of host system level events is done in parallel with sampling of host NIC counters 108. These events are recorded in a different database along with “markers.” The PPE 124 extracts all time periods with “markers” and uses the time period to analyze counters on that relevant host and the job executing in that host.

The Performance Analysis and Anomaly Detection System 102 also provides a real-time analysis for large scale HPC jobs to implement corrective actions. For example, a job that is impacted heavily needs to be corrected before wasting valuable system time. Pre-processing with markers for high impact events and thresholds (e.g., events and/or thresholds of interest as selected by a system or operator) with a correlation of switch side, host NIC, and host system metrics provide the ability to focus on high impact anomalies in real-time (e.g., via the Marker-Based GUI 104).

As may be appreciated, the Performance Analysis and Anomaly Detection System 102 may provide: an ability to automate network performance analysis for large scale systems, performance anomaly detection and job failure analysis for networks and related hardware, an ability to correlate host side with fabric side metrics and events in a highly automated fashion, correlation of system events (PCIe, memory issues) impacting performance of jobs, simplify visual representation using derived metrics for large endpoint counts (e.g., via the Marker-Based GUI 104), and an ability to provide real-time analysis for large scale systems (e.g., via the Marker-Based GUI 104).

FIG. 1B is a diagram, illustrating a system 120 with a pre-processing engine 122 and a post-processing engine 124, in accordance with aspects of the present disclosure.

The pre-processing engine 122 is tasked with receiving metrics from host(s)/node(s) 126 and/or fabric components, such as switch(es) 128.

The host(s)/node(s) 126 may include a host NIC agent 130 that provides events and/or metrics 132 from host system counter(s) 134 and events and/or metrics 136 from host NIC counter(s) 138 to the pre-processing engine 122, which may be accumulated, respectively, by host system metrics collector 140 and Host NIC metrics collector 142 and stored, respectively in host system metrics database 144 and Host NIC metrics database 146. The host NIC counters 148 may generate events and/or metrics 146 associated with the Host NIC agents 130 and the host system counters may generate events and/or metrics 132 associated with hardware 148 of the host(s)/node(s) 126.

The host(s)/node(s) 126 also include an operating system (OS) 150, as well as any platform services/software development kits (SDKs), and/or drivers 152 associated with the OS 150.

The switch 128 includes a switch agent 154 that interacts with the fabric manager 156. This switch 128 also includes an operating system (OS) 158, as well as any drivers associated with the OS 158. The switch 128 further includes hardware 160, such as physical ports (e.g., edge ports and fabric ports), a collection of processors, a collection of memory devices, a collection of persistent storage devices, a collection of input/output (I/O) devices, and so forth. The switch agent 154 and the OS 158 (and any associated drivers) are implemented using machine-readable instructions executable on the collection of processors in the hardware 160.

The switch agent 154 includes a telemetry agent 162 that is used to monitor the health of the switch 128. The telemetry agent 162 may include machine-readable instructions executable on hardware processing circuitry. Hardware processing circuitry can include any or some combination of a microprocessor, a core of a multi-core microprocessor, a microcontroller, a programmable integrated circuit, a programmable gate array, or another hardware processing circuit.

The telemetry agent 162 collects events and/or metrics 164 of the switch 128, which may be stored in a datastore 166. Examples of metrics of a switch 128 that can be monitored by the telemetry agent 162 can include any or some combination of the following: an error rate of a port or link, a status of a port (e.g., active, inactive, etc.), an indication of congestion of the switch 128 (e.g., queues in the switch 128 have filled up over a threshold amount), bandwidth usage of a port, quantity of data units discarded or dropped by a switch 128, and so forth.

In some examples, the telemetry agent 162 can store collected metrics in a data store 166 of the switch 128, for use by the switch 128 locally. The data store 166 can be implemented using a collection of storage devices, such as disk-based storage devices, solid state drives, memory devices, and so forth. The telemetry agent 162 can also transmit events and/or metrics 168 to the pre-processing engine 122 and more-specifically to fabric metrics collector 170, which may store the events and/or metrics 168 in fabric metrics database 172.

In some cases, the telemetry agent 162 is able to generate events based on sampled metrics by the telemetry agent 162. Events may also be based on hardware events such as a cable reseat, or another hardware event. Events are asynchronously sent as the events occur. The telemetry agent 162 can store events and/or metrics 164 in the data store 166. An “event” refers to a notification that is generated when specified condition(s) occur. An event that is indicative of an issue with the switch 128 or a link connected to the switch 128 produces an alert 186. Thus, an alert 186 is a special type of event with some indicator (e.g., a flag in the alert) that an issue has occurred. For example, if an error rate exceeds a first threshold, the telemetry agent 162 can generate an event.

The pre-processing engine 122 may generate markers when received events are present and/or metrics breach an associated threshold defined in the pre-processing template 174, resulting in a markable event. Thus, as the events and/or metrics 132, 136, and/or 168 are received by their respective collectors (host system metrics collector 140, host NIC metrics collector 142, and fabric metrics collector 170), these collectors may generate a marker for received events and may also compare corresponding threshold values provided by the pre-processing template 174 and generate a marker when a metric breaches its corresponding threshold. The generated markers may be stored in a respective database (e.g., host system metrics database 144, host NIC metrics database 146, and/or fabric metrics database 172.

The post-processing engine 124 may include a host system processing service 176 tasked with identifying markers in the host system metrics database 144, a host NIC processing service 178 tasked with identifying markers in the host NIC metrics database 146, and/or a fabric processing service 180 tasked with identifying markers in the fabric metrics database 172. Upon identifying markers, the post processing engine 124 may correlate the markers with other metrics and/or identified markers. For example, metrics and/or markers occurring within a time window associated with a time corresponding to a marker may be correlated with the marker. The correlations made by the post processing engine 124 may be used to facilitate health monitoring and/or control of the system 120. For example, the correlation may, in some cases, be used to provide events and/or metrics that occur during a zone of interest.

The post processing engine 124 may also interface with the fabric manager 156. The fabric manager 156 provides control plane 182 and fabric management functionality. A health service 184 of the fabric manager 156 may provide additional events and/or metrics to the fabric processing service 180 (e.g., based upon alerts 186 provided to health service 184 from switch 128). Upon identification of a root cause associated with one or more events and/or problematic metrics, the control plane 182 may be used to adjust one or more features of the fabric, such as adjusting a configuration (e.g., altering a routing table) of a fabric component (e.g., switch 128).

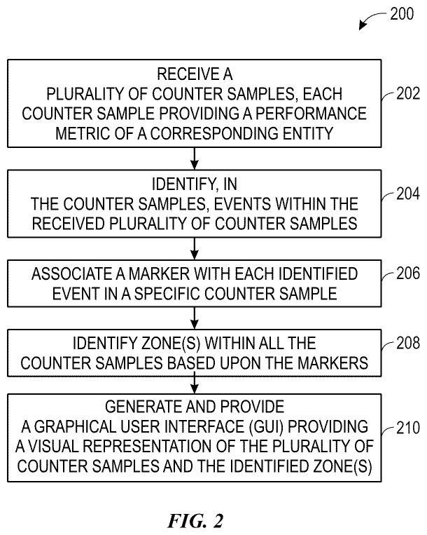

FIG. 2 is a flowchart, illustrating a process 200 to provide efficient counter sample analysis, in accordance with aspects of the present disclosure. Process 200 begins by receiving a plurality of counter samples with each counter sample providing a performance metric of a corresponding entity (block 202). Overall job performance analysis involves an analysis of different counters from all the entities such as counters on the switches, counters on the NICs on the hosts, and a set of system level counters on the hosts with different types of metrics. Because host side counters and fabric side counters represent different components, the schemas used by these counters oftentimes differ. In some cases, to accumulate host side counters with the fabric side counters, during metric collection the counter samples of the different counters may be accumulated into a common data store with a common schema.

For each of the received counter samples, events are identified (block 204). For example, events may be identified when performance metrics breach an event threshold (e.g., exceed a maximum associated threshold and/or fall below a minimum associated threshold). The event thresholds indicating when a counter sample value indicates an event may differ from counter to counter. For example, a first event threshold may be used to indicate when counter sample values associated with a first specific measured counter value indicate a first event and a second event threshold may be used to indicate when counter sample values associated with a second specific measured counter value indicate a second event. The event thresholds may include, for example, a performance metric value threshold, a performance metric rate of change threshold (e.g., how quickly a performance metric changes and/or a magnitude of change of a performance metric over a given amount of time), and/or an occurrence threshold (e.g., a particular number of times (e.g., 1 or 10) a monitored performance activity occurs (e.g., a timeout or packet drops). A template may specify the counters and the corresponding thresholds that should be used for identifying an event.

In some cases, events may be identified from a counter sample event indication observed within the counter sample. For example, a timeout event and/or an event associated with an uncorrectable error may be indicated as an event within the counter sample.

For each of the received counter samples, within the corresponding counter sample, a marker with each of the one or more events are associated (block 206). These “markers” signify priority events or periods where counters exceed the event thresholds (e.g., known good thresholds). The counter sample values may be compared with an associated threshold to identify an event and/or an event may be indicated in the counter samples without comparing a counter sample value with a threshold, such as when a timeout occurs and/or when other events are indicated in the counter samples (e.g., the presence of uncorrectable errors). In some cases, these markers are recorded along with the sample data in a data store where the counter samples are stored. The markers may be applied for raw counter samples as well as counter sample deltas (differences from previous samples). Events may be positive and/or negative. For example, some positive events may occur when a performance metric exceeds particular performance metrics indicated by a positive baseline threshold. Negative events may occur when a performance metric falls below particular performance metrics indicated by a negative baseline threshold.

Zones within all the counter samples may be identified based upon the markers (block 208). For example, “healthy zones” may be identified in time windows where negative events do not occur and, thus, markers are not found/associated and/or when positive events occur and, thus, positive markers are present. “Unhealthy zones” may be found in time windows where negative events do occur and, thus, negative event markers are found/associated. Because the markers are associated with the counter sample data, “zones of interest” may be efficiently identified within the counter samples, by identifying these zones based on the time windows around the associated/inserted markers.

A graphical user interface (GUI) is generated and provided, which provides a visual representation of the plurality of counter samples, an indication of the one or more events using the marker associated with the one or more events, and an indication of the zones of interest (e.g., “unhealthy zones” and/or “healthy zones”) (block 210). Visual representation of the performance metrics, their respective events, and their corresponding zones with other counter performance metrics aids in troubleshooting the reason for a particular event (e.g., a stall). Thus, the process 200 enables efficient visual representation and timeline filtering, enabling pinpointing of particular time windows of interest within visualization of counter samples. Thus, enhanced visualization may be provided, emphasizing particular portions of the massive amount of counter sample data that may be important to view. The process 200 may further improve processing efficiencies by reducing an amount of counter sample data loaded by visualization tools, focusing specifically on loading the portions where markers and/or zones of interest occur within the counter samples and refraining from loading other portions of the counter sample data that are less relevant. This may result in a significant reduction in processing resource utilization, freeing up these resources for other tasks.

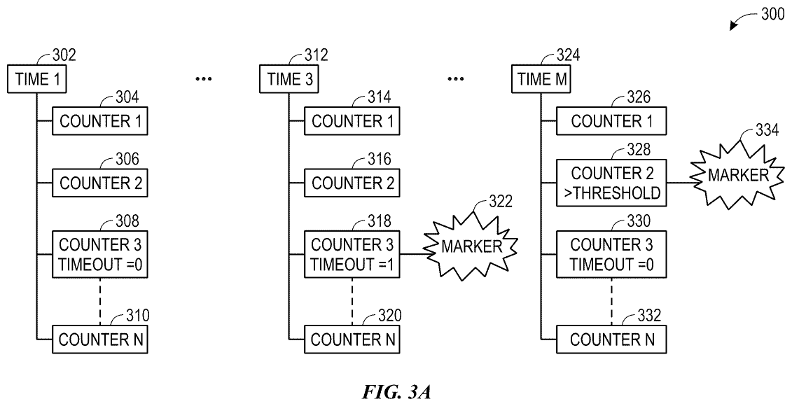

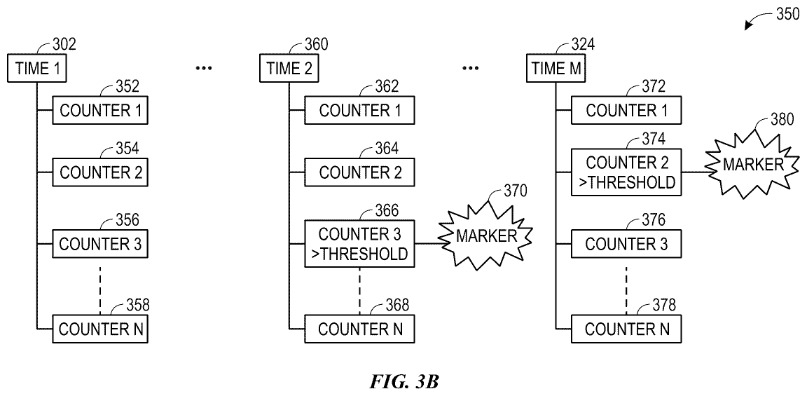

FIG. 3A is a diagram 300, illustrating an example of marker insertion with respect to host metrics counter samples (e.g., host NIC and/or host system counter samples), in accordance with aspects of the present disclosure. Specifically, the illustrated example illustrates a marker insertion when a timeout has been detected and when one of the metrics has exceeded the acceptable threshold, in accordance with aspects of the present disclosure. At time 1 (illustrated by block 302), a plurality of counter samples 304-310 are captured. Counter sample 308 is a timeout indicator, indicating that no timeout has occurred.

At time 3 (illustrated by block 312), updated counter samples 314-320 are captured, where counter sample 318 provides an update to the counter sample 308 that indicates that a timeout has occurred. An event threshold for a timeout counter sample (e.g., counter sample 318) may indicate an event whenever a timeout occurs. Based upon the indication of the timeout in counter sample 318, a marker 322 indicating an anomaly in the counter sample 318 may be associated with the counter sample 318, as the timeout indicated by the counter sample 318 breaches the threshold. The marker associations may persist in accumulated counter sample data until the anomaly no longer exists. In this manner, the associated markers may provide an indication of particular time intervals when an anomaly existed within the counter samples.

At time m (illustrated by block 324), additional updated counter samples 326-332 are collected. As illustrated by counter sample 328, an anomaly (e.g., a metric exceeding a threshold value) has occurred. Based upon identifying this anomaly, a marker 334 is associated with the counter sample 328 indicating the anomaly. Further, the counter data 330 no longer indicates a timeout. Accordingly, the marker 322 is removed from association with the counter data 330.

The markers 322 and 334 provide an indication of particular counter samples of interest in performance analysis. A graphical user interface may provide enhanced counter sample visualizations that emphasis the particular counter sample 318 at time 3 and the counter sample 328 at time m. Further, these markers 322 and 334 may be used to pinpoint additional portions of other counter samples to analyze for anomalies and/or to cross-correlate with, thus enabling identification of zones of interest.

FIG. 3B is a diagram 350, illustrating an example of marker insertion with respect to fabric metrics counter samples, in accordance with aspects of the present disclosure. Specifically, the illustrated example illustrates a marker insertion when first and second events have been detected (e.g., when one of the metrics has exceeded the acceptable threshold), in accordance with aspects of the present disclosure. At time 1 (illustrated by block 302), a plurality of counter samples 352-358 are captured.

At time 2 (illustrated by block 360), updated counter samples 362-368 are captured, where counter sample 366 provides an update to the counter sample 356 that indicates an event (e.g., by exceeding a preset threshold for the counter sample 366). Based upon this identified event, a marker 370 indicating the event/an anomaly in the counter sample 366 may be associated with the counter sample 366, as the timeout indicated by the counter sample 318 breaches the threshold. The marker associations may persist in accumulated counter sample data until the anomaly no longer exists. In this manner, the associated markers may provide an indication of particular time intervals when an anomaly existed within the counter samples.

At time m (illustrated by block 324), additional updated counter samples 372-378 are captured. As illustrated by counter sample 374, an event/anomaly (e.g., a metric exceeding a threshold value) has occurred. Based upon identifying this anomaly, a marker 380 is associated with the counter sample 374 indicating the event and/or anomaly.

The markers 370 and 380 provide an indication of particular zones (e.g., windows of time) of interest in performance analysis. A graphical user interface may provide enhanced counter sample visualizations that emphasis the particular counter sample 366 at time 2 and the counter sample 374 at time m. Further, these markers 370 and 380 may be used to pinpoint additional portions of other counter samples to analyze for anomalies and/or to cross-correlate with, thus enabling identification of zones of interest.

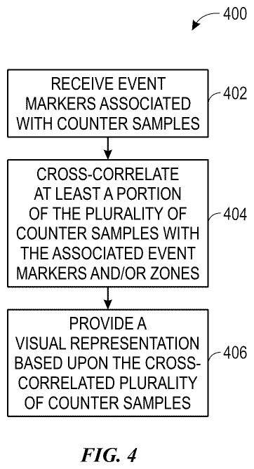

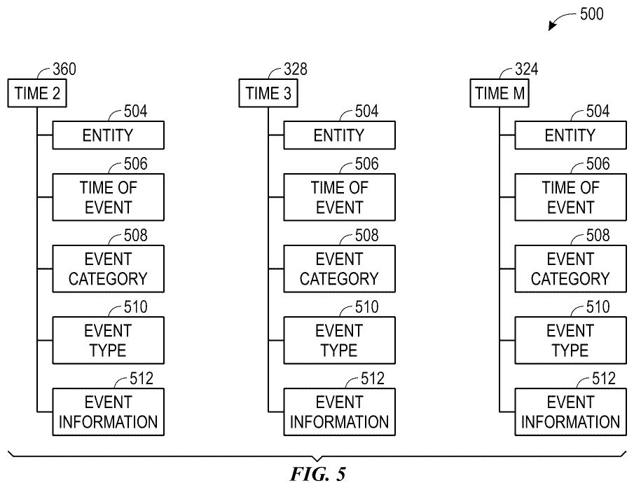

FIG. 4 is a flow chart, illustrating a process 400 for correlation of and visual presentation of counter samples, in accordance with aspects of the current disclosure. Process 400 begins by receiving event markers (e.g., both host side and fabric side markers), such as those generated in the example provided in FIGS. 3A and 3B (block 402). The event markers indicate events of interest within counter samples (e.g., counter sample values exceeding a threshold value associated with the counter sample type). When inserted directly into the counter sample data, the markers may be received by extracting the markers from the counter sample data. When the markers are stored elsewhere (e.g., in a database), the markers can be retrieved from their stored location. FIG. 5, which is described in more detail below, illustrates an example extraction of markers from the example counter samples provided in FIGS. 3A and 3B.

At block 404 the counter samples with associated event markers are cross-correlated with the other counter samples. Thus, for example, the plurality of counter samples received include fabric counters and host counters. Fabric counter collection on the switch side for edge ports is correlated to the hosts on which the jobs are launched. The host counter samples with associated markers may be cross-correlated with fabric counter samples and fabric counter samples with associated event markers may be cross-correlated with host samples. Accordingly, events which occurred in the fabric counter samples (e.g., either indicated in the fabric counter sample and/or identified based upon a metric value breaching a threshold) during the jobs (for example a link failure, lack of buffers in ports, invalid switch configuration, switch failures, correctable/uncorrectable errors) may be correlated with host counter samples to identify correlations between performance variations or job failure to specific events. Correlation of all the metrics during this time enables understanding of the reason for the timeout.

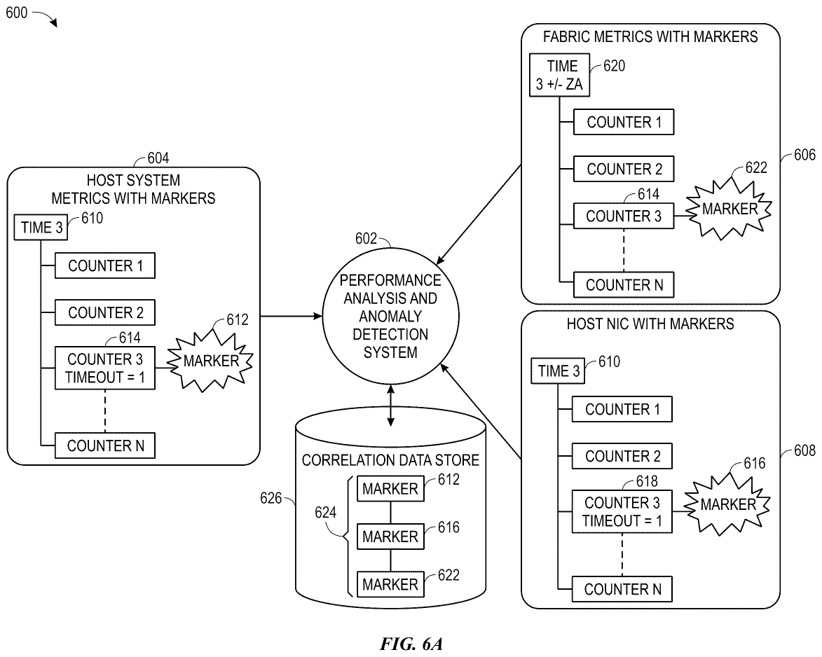

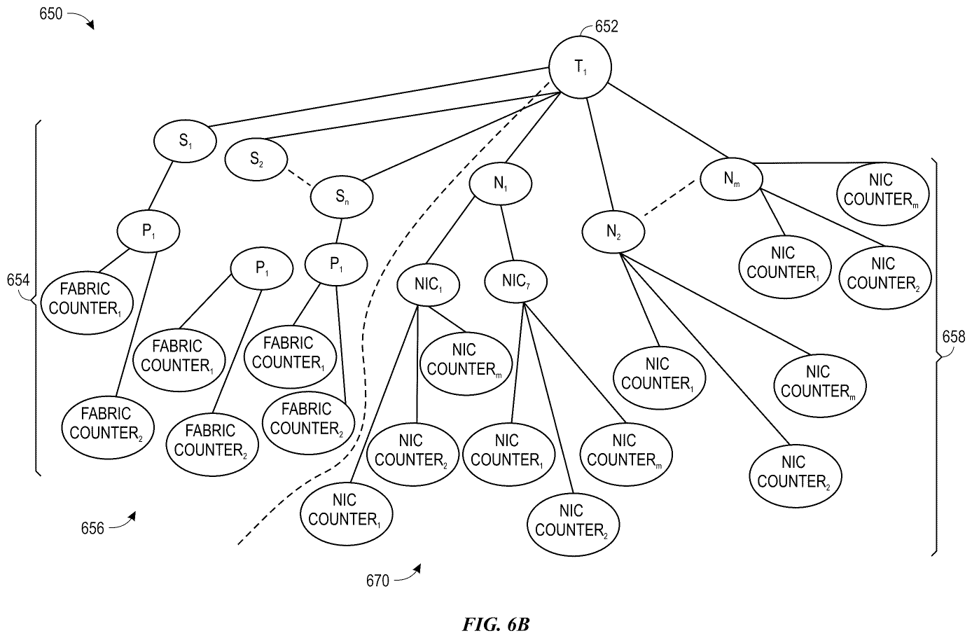

Cross-correlation between counter samples may involve identifying metrics of the various counter samples with respect to a particular common time. For example, when correlating a host counter sample event with a fabric counter sample, the cross-correlation may include identifying the fabric counter sample values occurring at a common time that a host counter sample event occurred (e.g., as indicated by an associated marker in the host counter sample). In some cases, the cross-correlation may include identifying cross-correlated events between counter samples, which may include identifying a subset of other counter samples where an event occurs (e.g., as indicated by a marker in the subset of other counter samples) at a common time and/or time window. Thus, in such cases, cross-correlating a host counter sample event with a fabric counter sample would include identifying a subset of fabric counter samples that include an event (e.g., as indicated by an associated marker) occurring a common time and/or time window of the occurrence of the host counter sample event. FIGS. 6A and 6B, discussed in more detail below, provide illustrations of correlated counter samples.

At block 406, a visual representation (e.g., via a graphical user interface (GUI) may be presented based upon the cross-correlated plurality of counter samples. For example, zones of interest surrounding the events/markers may be used to filter portions of the counter samples for processing and/or presentation. Thus, the visualization of the counter samples may be filtered to prioritize the zones of interest and correlated counter samples. This may result in far less data but more meaningful data being presented via counter sample visualization tools, reducing inundation in processing and/or visualization of the vast amounts of available counter sample data.

The visual representation may be a derived metrics data representation which displays metrics related to the job either due to the performance variations or as the cause of job failures. The graphical user interface (GUI) indicates a simplified visual representation of the marked anomalies across the plurality of counter samples correlated from different entities. The simplified visual representation includes derived metrics and provides a real-time analysis of the job performance. Visual representation of relevant prioritized data aids in implementing any corrective actions without wasting valuable time and resources.

FIG. 5 illustrates an example event data 500 obtained via extraction of markers stemming from the example provided in FIGS. 3A and 3B. As illustrated, the marker extraction provides event data 500 for times when markers were generated/associated with counter sample data. Referring back to FIG. 3A, host side markers 322 and 334 were generated and/ associated with counter samples 318 and 328 at time 3 (illustrated by block 312) and time m (illustrated by block 324), respectively. Referring back to FIG. 3B, fabric-side markers 370 and 380 were generated/associated with counter samples 366 and 374 at time 2 (illustrated by block 360) and time m (illustrated by block 324), respectively. Accordingly, the marker extraction includes event data 500 associated with each of these times. As illustrated, the event data 500 may include Entity data 504, which may specify a particular component in the system (e.g., system 100 of FIG. 10). Entity data 504 can specify, for example, a particular switch, NIC, CPU, GPU, PCIe, memory of the system that the corresponding counter is tracking.

The event data 500 may also include time of event data 506, which stores the time at which an event took place. This time of event data 506 may represent, for example, a specific time when an event, such as a timeout or one of the metrics exceeding an event threshold has occurred.

The event data 500 may include event category data 508 used to group the events into a broader classification. For example, the event category data 508 may indicate whether the event is host-side (e.g., system event and/or a host event) and/or is a fabric-side (e.g., a fabric event). Events can have varied durations. Some may appear relatively instantaneous (e.g., in a magnitude of milliseconds) while others may have a longer duration. The event category may be used to determine a time window length with which to define a corresponding zone and/or correlate other counter samples.

The event type data 510 describes the type of event that occurred. For example, the event type data 510 may indicate a timeout event or other type of event. An event ID may be used, such as a number that specifies the type of event. For example, one event ID may indicate a timeout type of event, while a second event ID may indicate a particular type of metric exceeding a particular corresponding threshold.

The event information 512 is the data associated with the entity during the event. For example, the event information 512 may include recorded information, such as actual observed performance metric values observed resulting in the event.

The marker extraction and/or accumulated event data 500 indicative of the events present in the counter samples may be used to correlate the counter samples. This is illustrated in more detail with respect to FIGS. 6A and 6B.

FIG. 6A is a diagram, illustrating a system 600 that correlates counter samples across fabric, host NIC, and host system domains, here specifically correlating events across the domains. As illustrated, the system 600 includes the Performance Analysis and Anomaly Detection System 602 (e.g., Performance Analysis and Anomaly Detection System 102 of FIG. 1) by correlating the “markers” from the host and fabric side counters. Data from the host counter samples 604, fabric counter samples 606, and host NIC counter samples 608 are analyzed in the performance analysis and anomaly detection system 602 to identify markers based upon breached values with respect to thresholds set for the specific counter types.

In the current example, at time 3 (illustrated by block 610), a marker 612 indicating an anomaly in the counter sample 614 may be associated with the host counter sample 614 due to the host counter sample 614 indicating a threshold breach (e.g., existence of a timeout). Also, at time 3 (illustrated by block 610), a marker 616 indicating an anomaly in the counter sample 618 may be associated with the host NIC counter samples 608.

For the fabric counter samples 606, at time 3 +/−zone allowance (za) (illustrated by block 620), a marker 622 indicating an anomaly in the counter sample 614 may be associated with the counter sample 614. The fabric counter sample 606 includes a zone allowance (za) applied to time 3 on the time represented by block 620. The zone allowance specifies a certain time window with which correlation between events may occur. Thus, the fabric marker 622 will be correlated with the host system metrics marker 612 and host NICs marker 616. However, had the marker 622 been outside the zone allowance, there will be no correlation of marker 622 with the other markers 612 and 616.

The zone allowance (za) may be a set duration specified specifically for a particular job, particular type of event, and/or may be a default pre-defined duration. By providing an adjustable za, flexibility may be provided in correlation of events.

Here, because markers 612, 616, and 622 all occur at time 3 or at least within the zone allowance of time 3, each of these markers may be correlated with one another. As illustrated, the Performance Analysis and Anomaly Detection System 602 may store the correlation 624 in a correlation data store 626. The correlation 624 may indicate a correlation between each of the markers 612, 616, and 622 as shown.

The correlation 624 based upon correlated events provides an indication of all the correlated events within a particular zone of interest (e.g., defined by the time an event occurs +/−the zone allowance). Thus, this time-based correlation of the markers in the correlation data store 626 may be used to emphasize the correlated events, by providing a specific visualization that removes non-correlated counter samples. In this manner, efficient analysis and visualization is provided, improving efficiency in analyzing job performance within the system.

Not all cross-correlation correlates events to other events. Indeed, as mentioned above, cross-correlation may correlate counter samples based upon a marker being observed at a particular time in one of the counter samples. In such cases, a lack of events within a zone of interest may still be of interest, as such lack of occurrence may indicate that one event observed within a zone of interest does not appear to correlate to events at another entity, as indicated by a lack of events within a counter sample associated with that entity during the zone of interest.

FIG. 6B illustrates cross-correlated counter samples 650 resulting from cross-correlation of the counter samples. Here, at time T1, indicated by node 652, a marker is observed (e.g., associated with at least one counter sample). Based upon this observance, counter samples 654 of the fabric side 656 at time T1 and counter samples 658 of the host NIC side 670 occurring at time T1 are correlated, enabling correlation visualizations and analysis to be performed. For example, counters 654 may include counters for particular switches (e.g., S1-Sn) and their respective ports (e.g., P1). Counters 658 may include particular host NIC counters for particular host NICs (e.g., NIC1, NIC7) and/or particular hosts/nodes (N1-Nm). Using the current cross-correlation techniques, correlation analysis between the fabric side 656 and the host NIC side 670 may be facilitated.

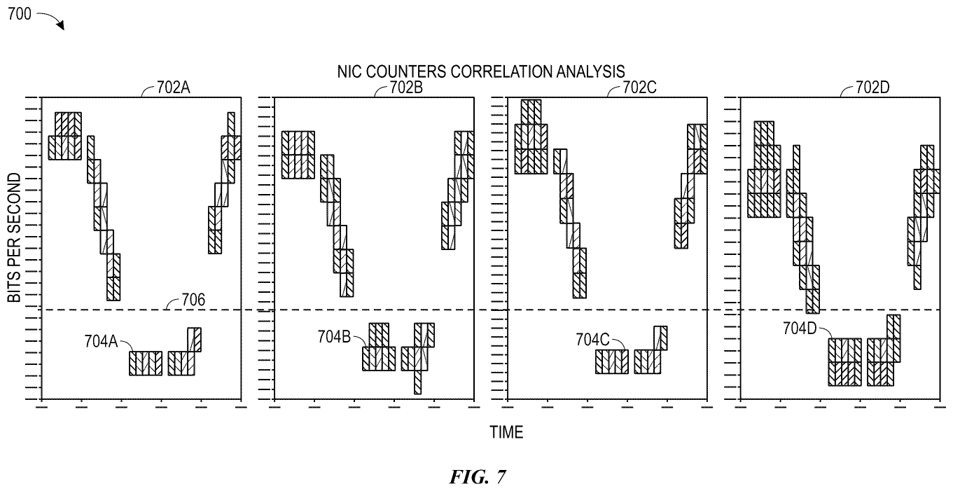

FIG. 7 depicts a graphical user interface (GUI) visualization 700 of a visualization tool, providing an example of correlated counter samples and their benefits. Specifically, the example provided by GUI visualization 700 includes correlated network interface controller (NIC) counter samples 702A-702D, which have been correlated based upon correlated events 704A-704D, in accordance with aspects of the present disclosure. The x-axis shows the time, and the y-axis shows the rate of bits per second. The correlation analysis indicates when the system has detected an event across each of counter samples 702A-702D (e.g., because the bits per second have fallen below a threshold 706) as shown. The events 704A-704D show that each of the associated NIC counters has gone idle. The automated correlation of events 704A-704D (e.g., by the visualization tool) may be quite useful in providing a real-time analysis of the job performance variation. For example, here, because each of the associated NICs go idle, this may indicate a problem elsewhere within the system (e.g., a problem with data reaching the NICs) as opposed to a problem with one of the NICs. Thus, the current techniques, by efficiently and effectively providing correlated events, may provide a rapid understanding of important performance variables in the system.

As may be appreciated, any number of correlated events and/or metrics may be observed with the current techniques. For example, in one case, a number of cycles per packet exceeding an associated event threshold may indicate an event (e.g., indicated with a marker) that can be correlated, in the visualization 700, with other counter samples to identify metrics and/or events correlated with the cycle per packet event. In this manner, events and/or metrics associated with other counter samples can be viewed concurrently to diagnose causes and effects of events within the larger system. For example, the high cycle per threshold count may be attributed with host level PCIe metrics based upon correlated PCIe metrics visualized with the cycle per packet event.

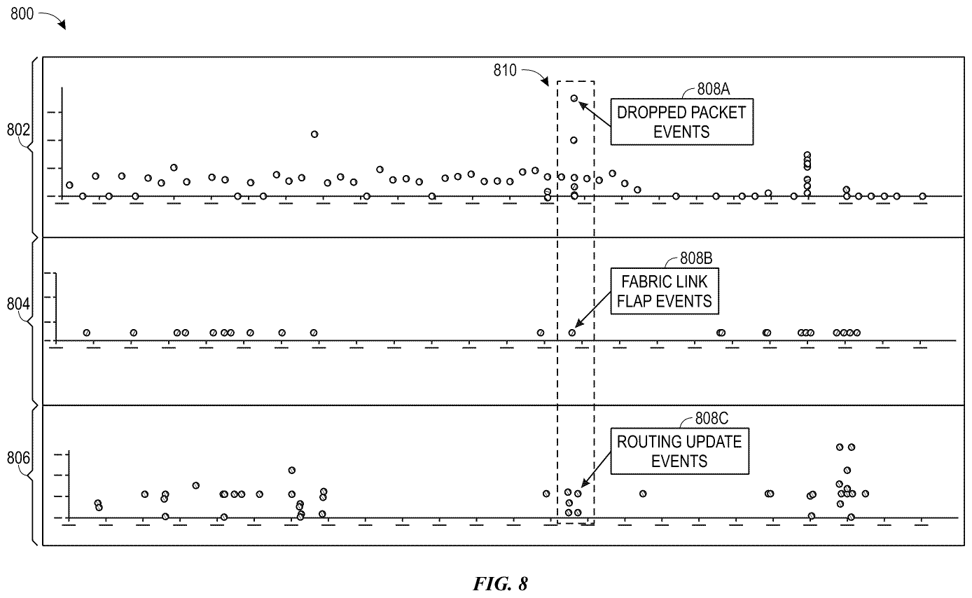

FIG. 8 depicts a GUI visualization 800 of a visualization tool that provides a visual representation of correlated events across the host side and fabric side. For example, here, the GUI visualization 800 visualizes three different counter samples, a dropped packet counter sample 802, a fabric link flap event counter sample 804, and a routing event update counter sample 806. The visualization tool may correlate these counter samples 802-806 based upon a marker appearing in one of the counter samples (when correlating an event to other counter samples) and/or markers appearing in each of the counter samples (when correlating events across counter samples). Here, the visualization tool provides, in the GUI visualization 800, both types of correlation. For example, other relevant counter samples are brought in and correlated in the visualization 800 based upon an event occurring within one of the counter samples. Thus, the correlated view, illustrating the counter sample values at common time intervals is provided (e.g., here, a stacked view with each of the counter samples stacked with respect to time). Further, the visualization tool identifies correlated events within the counter samples. Here, for example, correlated events (e.g., indicated by indicia 808A-808C visualized in the GUI visualization 800) across a zone of interest are identified across the visualized counter samples 802-806. A visual indicia 810 is rendered to emphasize this correlation of events across the counter samples 802-806. Thus, as may be appreciated, the marked events and/or correlations may be emphasized in the GUI visualization 800, providing efficient performance analysis.

As may be appreciated, the current techniques provide significant value. The proposed solution has the ability to automate network performance analysis for large scale systems, perform an anomaly detection and a job failure analysis for networks and related hardware, correlate host side with fabric side metrics and events in a highly automated fashion, correlate system events (PCIe, memory issues) impacting the performance of jobs, simplify visual representation using derived metrics for large endpoint counts, and provide real-time analysis for large scale systems.

While certain features of the present disclosure have been illustrated and described herein, many modifications and changes will occur to those skilled in the art. It is, therefore, to be understood that the appended claims are intended to cover all such modifications and changes as fall within the true spirit of the present disclosure.

1. A computer-implemented method, comprising:
receiving a plurality of counter samples, each of the plurality of counter samples providing a performance metric of a corresponding entity;
for each of the received plurality of counter samples:
identifying, in a corresponding counter sample, one or more events based upon a corresponding metric breaching a threshold, an indication of an event within the corresponding counter sample, or both;
associating a marker with each of the one or more events;
identifying one or more zones within the plurality of counter samples based upon the markers; and
generating and providing a graphical user interface (GUI) providing a visual representation of the plurality of counter samples and the identified one or more zones.

2. The computer-implemented method of claim 1, comprising:
filtering out, from the visual representation of the plurality of counter samples in the GUI, at least a portion of the plurality of counter samples that are not associated with the one or more events.

3. The computer-implemented method of claim 2, comprising:
identifying that a client computer that the GUI is provided to comprises a computer processing resource limitation; and
filtering the visual representation based upon the client computer comprising the computer processing resource limitation.

4. The computer-implemented method of claim 1, comprising:
generating and providing, via the GUI, an affordance to specify thresholds corresponding to the plurality of counter samples that, when breached, indicate an event.

5. The computer-implemented method of claim 1, comprising:
generating and providing, via the GUI, an affordance to specify one or more counter samples that, when exceeding a priority event threshold, signify priority events; and
generating and providing, in the GUI, a visual representation of the priority events.

6. The computer-implemented method of claim 1, wherein:
the plurality of counter samples comprise at least one fabric-side counter and at least one host-side counter; and
the computer-implemented method comprises:
correlating events of both the at least one fabric-side counter and the at least one host-side counter.

7. The computer-implemented method of claim 6, wherein the at least one host-side counter comprises at least one network interface controller (NIC) counter and at least one host system counter.

8. The computer-implemented method of claim 6, wherein the at least one fabric-side counter and at least one host-side counter are independently captured and stored via respective different first and second schemas in respective different first and second persistent databases.

9. The computer-implemented method of claim 6, comprising:
correlating events of a switch-side performance counter with events of at least one of: a network interface controller (NIC) performance counter, a peripheral component interconnect express (PCI-e) performance counter, a graphics processing unit (GPU) performance counter, a central processing unit (CPU) performance counter, or a dual in-line memory module (DIMM) performance counter.

10. The computer-implemented method of claim 1, wherein the threshold comprises at least one of: a rate of change threshold for the performance metric or a performance value threshold for the performance metric.

11. The computer-implemented method of claim 1, comprising:
identifying the plurality of counter samples from a larger plurality of counter samples based upon the plurality of counter samples being associated with a particular job that is being evaluated.

12. The computer-implemented method of claim 1, comprising:
cross-correlating at least a portion of the plurality of counter samples with one or more other portions of the plurality of counter samples based on at least one of the identified one or more zones; and
generating and providing, in the GUI, a visual representation based upon the cross-correlating.

13. The computer-implemented method of claim 12, wherein the cross-correlating comprises:
correlating first events of a first counter sample with second events of a second counter sample different than the first counter sample.

14. A system, comprising:
a performance analysis and anomaly detection system configured to:
receive a plurality of counter samples, each of the plurality of counter samples providing a performance metric of a corresponding entity;
for each of the received plurality of counter samples:
identify, in a corresponding counter sample, one or more events based upon a corresponding metric breaching a threshold, an indication of an event within the corresponding counter sample, or both;
associate a marker with each of the one or more events;
identify one or more zones within the plurality of counter samples based upon the markers; and
generate and provide a graphical user interface (GUI) providing a visual representation of the plurality of counter samples and the identified one or more zones.

15. The system of claim 14, wherein the performance analysis and anomaly detection system is configured to:
filter the visual representation of the plurality of counter samples in the GUI such that at least a portion of the plurality of counter samples that are not associated with the one or more events are not presented.

16. The system of claim 14, wherein the performance analysis and anomaly detection system is configured to:
cross-correlate events of at least one fabric-side counter with events of at least one host-side counter; and
wherein the at least one host-side counter comprises at least one network interface controller (NIC) counter and at least one host system counter.

17. The system of claim 14, wherein the performance analysis and anomaly detection system is configured to:
cross-correlate events of a switch-side performance counter with events of at least one of: a network interface controller (NIC) performance counter, a peripheral component interconnect express (PCI-e) performance counter, a graphics processing unit (GPU) performance counter, a central processing unit (CPU) performance counter, or a dual in-line memory module (DIMM) performance counter.

18. The system of claim 14, wherein the performance analysis and anomaly detection system is configured to:
cross-correlate the at least one of: the identified one or more events or the identified one or more zones with other counter samples of the plurality of counter samples; and
generate and provide, in the GUI, a visual representation based upon the cross-correlating.

19. A non-transitory computer-readable medium, comprising computer-readable instructions that, when executed by one or more processors of one or more computers, cause the one or more computers to:
receive a plurality of counter samples, each of the plurality of counter samples providing a performance metric of a corresponding entity;
for each of the received plurality of counter samples:
identify, in a corresponding counter sample, one or more events based upon a corresponding metric breaching a threshold, an indication of an event within the corresponding counter sample, or both;
associate a marker with each of the one or more events;
identify one or more zones within the plurality of counter samples based upon the markers; and
generate and provide a graphical user interface (GUI) providing a visual representation of the plurality of counter samples and the identified one or more zones.

20. The non-transitory computer-readable medium of claim 19, comprising computer-readable instructions that, when executed by the one or more processors of the one or more computers, cause the one or more computers to:
cross-correlate the at least one of: the identified one or more events or the identified one or more zones with other counter samples of the plurality of counter samples; and
generating and providing, in the GUI, a visual representation based upon the cross-correlating.
